(19) United States
(12) Patent Application Publication
(10) Pub. No.: US 2009/0310678 A1
(43) Pub. Date: Dec. 17, 2009

(54) IMAGE ENCODING APPARATUS, METHOD OF CONTROLLING THE SAME AND COMPUTER PROGRAM

(75) Inventor: Eiichi Tanaka, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/480,919

(22) Filed: Jun. 9, 2009

(30) Foreign Application Priority Data
Jun. 11, 2008 (JP) 2008-153394

(51) Int. Cl. H04N 7/26; G06K 9/36

(52) U.S. Cl. 375/240.15; 382/238; 375/E07.147; 375/240.13

(57) ABSTRACT

An image encoding apparatus that performs intra-frame predictive encoding is provided. The apparatus includes a partitioning unit configured to partition an inputted macroblock into blocks as processing units, an encoding unit configured to encode each of blocks to be processed using a prediction value for each pixel contained in the block to be processed, the prediction value being calculated by referring to pixels contained in other blocks, and a sorting unit configured to sort the encoded blocks in a predetermined encoding order. The encoding unit starts encoding in an order in which the first block for which all the pixels to be referred to are available for calculation of the prediction value is the first to be encoded, and the encoding is performed by pipeline processing.

### BACKGROUND OF THE INVENTION

1. Field of the Invention

The present invention relates to an image encoding technique, and particularly relates to an image encoding technique with respect to an intra-frame predictive encoding process.

2. Description of the Related Art

MPEG-4 and H.264 are known as image encoding systems adopting an encoding method that performs intra-frame prediction. Intra-frame prediction in H.264 is an evolution of intra-frame prediction in MPEG-4 and can enhance encoding efficiency. The main differences in intra-frame predictive encoding between MPEG-4 and H.264 are that the number of data items to be predicted is increased, the number of blocks to be referred to is increased, the direction of prediction is encoded, the number of types of blocks to be predicted is increased, and so on.

Hereinafter, intra-frame predictive encoding for blocks of 4×4 pixels each in H.264 will be described using FIGS. 10 to 13. FIG. 10 is a diagram showing prediction directions when intra-frame predictive encoding of a luminance signal is performed in units of 4×4 pixel blocks. Hatched pixels are pixels used for prediction, hollow pixels are pixels of a block to be encoded, and the arrows indicate the direction of prediction. Blocks used for prediction are blocks located in four different directions from, that is, to the upper left, above, to the upper right, and to the left of, the block to be encoded. There are a total of nine prediction modes as follows, each prediction mode indicating its own direction of 4×4 pixel intra-frame prediction in H.264. Prediction mode 0 is vertical prediction in which adjacent pixels above the block to be encoded are used for prediction. Prediction mode 1 is horizontal prediction in which adjacent pixels to the left of the block to be encoded are used for prediction. Prediction mode 2 is average value prediction in which an average value of one adjacent pixel to the upper left of the block to be encoded and adjacent pixels above and to the left of the block to be encoded is used for prediction. Prediction mode 3 uses adjacent pixels above and to the upper right of the block to be encoded. Prediction mode 4 is prediction that uses adjacent pixels to the upper left, above, and to the left of the block to be encoded. Prediction mode 5 is prediction that uses adjacent pixels to the upper left and above the block to be encoded for prediction. Prediction mode 6 is prediction that uses adjacent pixels to the upper left and to the left of the block to be encoded. Prediction mode 7 is prediction that uses adjacent pixels above and to the upper right of the block to be encoded. Prediction mode 8 is prediction that uses adjacent pixels to the left of the block to be encoded. As for prediction from obliquely to the lower left in prediction mode 8, a pixel of the lower left block is not used, and the lowest adjacent pixel of the block to the left of the block to be encoded is copied and used as the pixel obliquely to the lower left. It should be noted that the arrows are shown only to illustrate the concept of the prediction direction and are not to be construed to mean that only the pixels on the arrows are used for prediction. It is necessary that a pixel to be used for prediction has been encoded prior to encoding of the block to be encoded. For example, in prediction mode 4, pixels of three neighboring blocks, that is, blocks to the upper left, above, and to the left of the block to be encoded, are required, and so it is necessary that theses blocks have previously been encoded. From the nine prediction modes, one prediction direction that enables most appropriate prediction is selected and used as the prediction direction for the block to be encoded.

FIG. 11 is a diagram showing an encoding order of 4×4 blocks within a single macroblock consisting of 16×16 pixels. A “block” as simply expressed hereinbelow means a 4×4 block. White blocks are blocks to be encoded, and black blocks are blocks that have already been encoded during processing of other macroblocks. With a system compliant with the H.264 recommendation, encoding is performed in a Z pattern beginning with the upper left block, that is, in the order of upper left, upper right, lower left, and lower right, as shown by the arrows in FIG. 11. When encoding is performed in this order, any pixel used for prediction is necessarily encoded before each block is encoded.

An example of processing steps for performing 4×4 block intra-frame encoding will be described using FIG. 12. FIG. 12 is a diagram for explaining an example of an execution slot in the case where a single block is encoded. During an encoding process of a single block, 4×4 prediction 1201, mode determination 1202, integer transformation 1203, quantization 1204, inverse quantization 1205, inverse integer transformation 1206, and entropy encoding and the like 1207 are performed sequentially. Suppose that each processing step requires a processing time as shown in FIG. 12. For example, 4×4 prediction 1201 takes two units of processing time.

A case where the speed of the encoding process is increased by using a pipeline operation will be described using FIG. 13. FIG. 13 is a time chart in the case where the encoding process is performed in an order compliant with the recommendation. During processing of 4×4 prediction, in order for a certain block to be used as reference pixels, it is necessary that processing up to and including inverse integer transformation has been completed in that block. In other words, in order to start processing of 4×4 prediction 1302 for a block n+1, it is necessary to wait for the completion of processing up to and including inverse integer transformation 1301 for a block n. As a result, even when pipeline processing is performed, the activation rate of a circuit that performs each processing step is extremely low as shown in FIG. 13, and high-speed encoding cannot be expected.

As described above, when 4×4 blocks are encoded in the encoding order compliant with the recommendation, efficient parallel processing of the blocks to be encoded cannot be performed. For this reason, when high-speed processing is required, it is necessary to, for example, increase the operation frequency itself.

To address this issue, Japanese Patent Laid-Open No. 2004-140473 discloses a technique that enables parallel processing by changing the encoding order of 4×4 blocks and thus realizes a high-speed encoding process. However, since the encoding order is changed, the technique deviates from the recommendations of H.264. Furthermore, according to the above-described proposal, in order to speed up the encoding process, encoding of blocks to be encoded is performed by limiting the number of reference pixels to be referred to or using a predetermined value as a reference pixel when the reference pixel is not yet encoded. In this manner, encoding is performed using an original method, and so decoding cannot be performed with a decoder compliant with the H.264 recommendation, and a dedicated decoder is required.

As described above, there is a problem with 4×4 intra prediction in that image encoding compliant with the H.264 recommendation cannot be processed at high speed.

### SUMMARY OF THE INVENTION

According to one aspect of the present invention, an image encoding apparatus that performs intra-frame predictive encoding is provided. The apparatus includes a partitioning unit configured to partition an inputted macroblock into blocks as processing units, an encoding unit configured to encode each of blocks to be processed using a prediction value for each pixel contained in the block to be processed, the prediction value being calculated by referring to pixels contained in other blocks, and a sorting unit configured to sort the encoded blocks in a predetermined encoding order. The encoding unit starts encoding in an order in which the first block for which all the pixels to be referred to are available for calculation of the prediction value is the first to be encoded, and the encoding is performed by pipeline processing.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is an example of a functional block diagram of an image encoding apparatus 100 according to a first embodiment of the present invention.

FIG. 2 is a block diagram showing an example of the hardware configuration of the image encoding apparatus 100 according to the embodiment of the present invention.

FIG. 3 is an example of a flowchart for explaining an example of an encoding process according to the embodiment of the present invention.

FIG. 4 is a diagram for explaining an example of a macroblock 400 according to the embodiment of the present invention.

FIG. 5 is a diagram for explaining an example of the dependency between blocks according to the embodiment of the present invention.

FIG. 6 is an example of a diagram illustrating pipeline processing of blocks according to the first embodiment of the present invention along a time axis.

FIG. 7 is a diagram for explaining an example of a time chart of pipeline processing during a period 600 according to the first embodiment of the present invention.

FIG. 8 is a diagram for explaining an example of a time chart of pipeline processing according to a second embodiment of the present invention.

FIG. 9 is an example of a functional block diagram of an image encoding apparatus 100 according to the second embodiment of the present invention.

FIG. 10 is a diagram showing prediction directions when intra-frame predictive encoding of a luminance signal is performed in units of 4×4 pixel blocks.

FIG. 11 is a diagram showing an encoding order of 4×4 blocks within a single macroblock consisting of 16×16 pixels.

FIG. 12 is a diagram for explaining an example of an execution slot in the case where a single block is encoded.

FIG. 13 is a time chart in the case where an encoding process is performed in an order compliant with the recommendation.

### DESCRIPTION OF THE EMBODIMENTS

Hereinafter, embodiments of the present invention will be described with reference to the attached drawings.

### First Embodiment

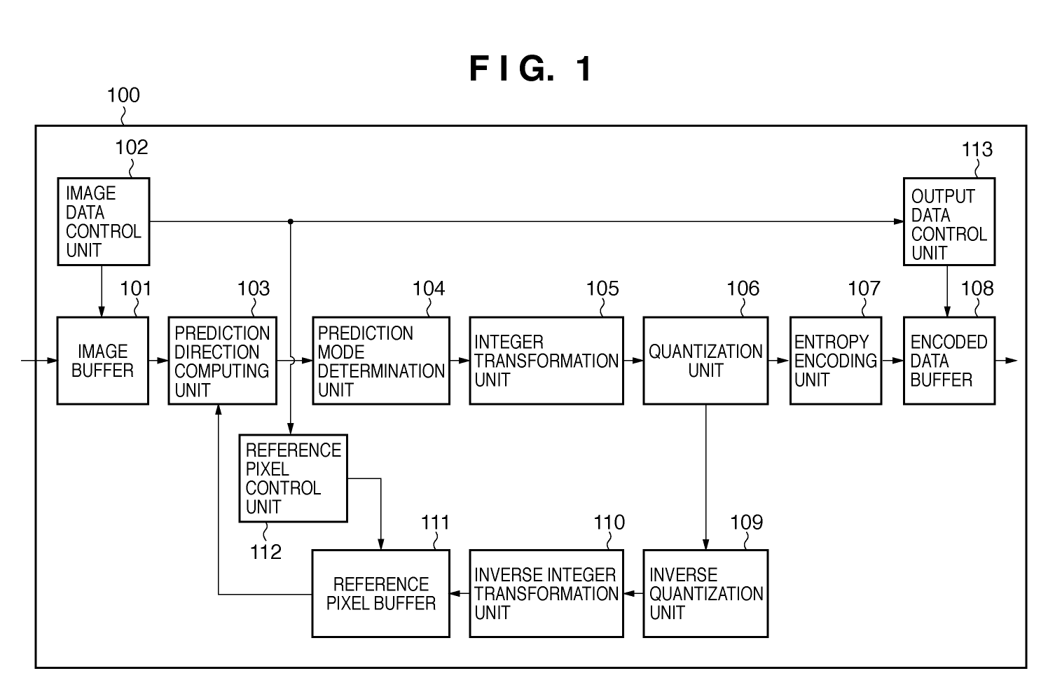

FIG. 1 is an example of a functional block diagram of an image encoding apparatus 100 according to a first embodiment of the present invention. All of the components may be implemented by hardware, or some of the components may be implemented by software. Input image data from an external camera or the like (not shown) is written to the image encoding apparatus 100 in units of macroblocks of 16×16 pixels. The macroblocks of the input image data are held in an image buffer 101.

An image data control unit 102 partitions each macroblock into blocks of 4×4 pixels each. A “block” as simply expressed hereinbelow means a block of 4×4 pixels. The image data control unit 102 then reads out a block to be processed from the image buffer 101. A prediction direction computing unit 103 calculates a difference value between a reference pixel and a pixel of the block to be encoded for each of a plurality of prediction directions. A prediction mode determination unit 104 selects the difference value for the optimum prediction direction from the results of computation by the prediction direction computing unit 103. An integer transformation unit 105 performs an integer transformation on the difference value selected by the prediction mode determination unit 104. A quantization unit 106 quantizes the resultant value of the integer transformation performed by the integer transformation unit 105. An entropy encoding unit 107 performs variable-length encoding on the value quantized by the quantization unit 106. An encoded data buffer 108 accumulates at least two blocks of data encoded by the entropy encoding unit 107.

An inverse quantization unit 109 performs inverse quantization on the value quantized by the quantization unit 106. An inverse integer transformation unit 110 performs an inverse integer transformation on the inverse-quantized value. A reference pixel buffer 111 accumulates pixels to be used for prediction. A reference pixel control unit 112 instructs the reference pixel buffer 111 what reference pixel is to be outputted according to control by the image data control unit 102. An output data control unit 113 reads out and outputs the encoded data from the encoded data buffer 108 in the order compliant with the recommendation, according to control by the image data control unit 102.

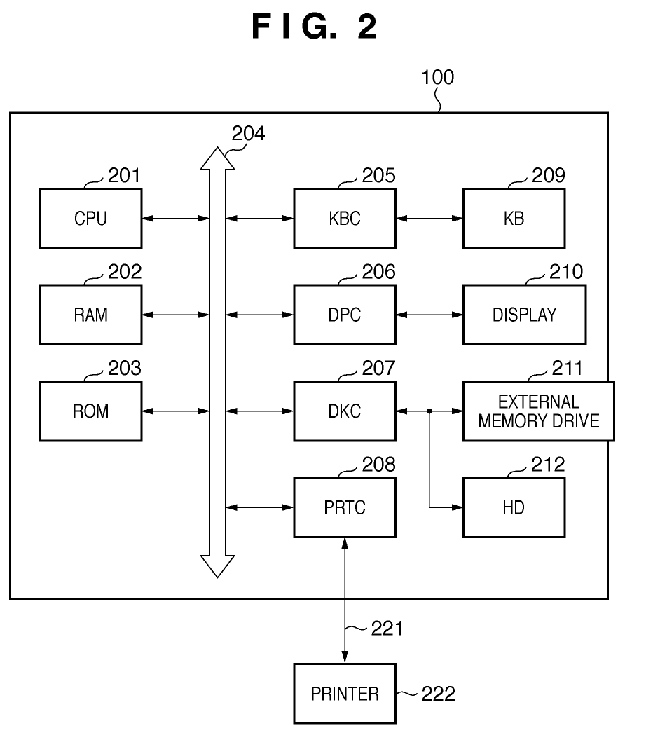

FIG. 2 is a block diagram showing an example of the hardware configuration of the image encoding apparatus 100. It should be noted that FIG. 2 shows a minimum configuration for realizing the configuration of the image encoding apparatus 100 corresponding to the embodiment of the present invention, and other mechanisms related to the image encoding apparatus 100 are omitted for simplicity of the description.

A CPU 201, which is a microprocessor, controls the image encoding apparatus 100 based on programs, data, or the like stored in a ROM 203, in a hard disk (HD) 212, or on a storage medium set in an external memory drive 211.

A RAM 202 functions as a work area for the CPU 201 and holds a program stored in the ROM 203, the HD 212, or the like. Moreover, the RAM 202 functions also as the above-described image buffer 101, encoded data buffer 108, or reference pixel buffer 111.

The ROM 203, the storage medium set in the external memory drive 211, or the HD 212 stores a program or the like, such as that shown by a later-described flowchart, the program or the like being executed by the CPU 201.

A keyboard controller (KBC) 205 controls input from a keyboard (KB) 209 or a pointing device, such as a mouse, which is not shown. A display controller (DPC) 206 controls display of a monitor 210. A disk controller (DKC) 207 controls access to the HD 212 and the external memory drive 211 and reads and writes various types of programs and various types of data, such as font data, a user file, and an edit file, from and to those storage media. A printer controller (PRTC) 208 is connected to a printer 222 via a predetermined bidirectional interface 221 and controls communication with the printer 222.

It should be noted that the CPU 201 executes a process of expanding (rasterizing) an outline font into, for example, a display information area allocated on the RAM 202 or a dedicated video memory (VRAM) to enable the outline font to be displayed on the monitor 210. Moreover, the CPU 201 opens various types of registered windows and executes various types of data processing based on commands given via a mouse cursor or the like on the monitor 210.

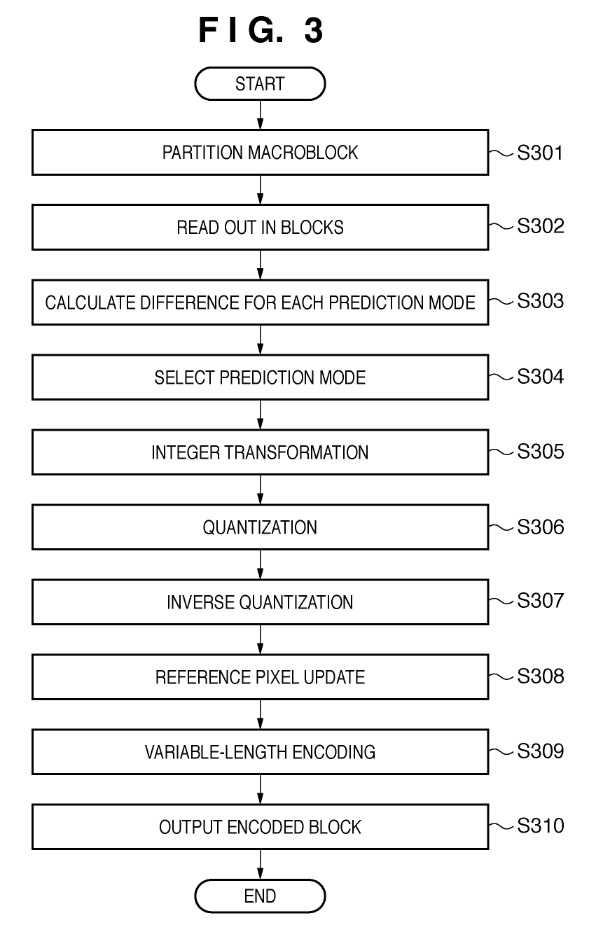

An encoding process with the image encoding apparatus 100 will be described using FIG. 3. FIG. 3 is an example of a flowchart for explaining an example of the encoding process. In this flowchart, the process for a single block will be described, and pipeline processing for a plurality of blocks will be described later. The process in this flowchart is performed by the CPU 201 executing a program written to the ROM 203. It should be note that the present embodiment deals with intra-frame predictive encoding only, and the description of inter-frame predictive encoding is omitted because it has no effect on the essence of the invention.

In step S301, the image data control unit 102 partitions a macroblock into blocks of 4×4 pixels each, which are the minimum units for intra-frame predictive encoding.

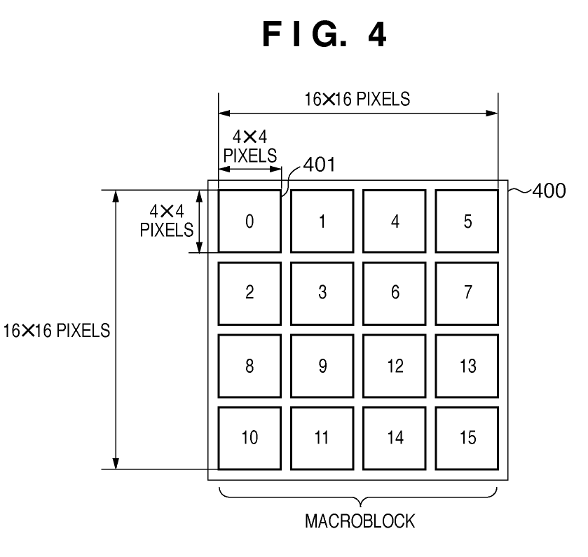

The blocks will be described using FIG. 4. FIG. 4 is a diagram for explaining an example of a macroblock 400. The macroblock 400 is partitioned into 16 blocks (B) 401 of 4×4 pixels each, each block serving as a processing unit. The numbers in the center of the blocks 401 indicate the encoding order compliant with the recommendation. Hereinafter, the 16 blocks will be denoted by B0 to B15 in accordance with this encoding order.

In step S302, the image data control unit 102 reads out the blocks 401 from the image buffer 101 to the prediction direction computing unit 103 one by one according to an order and timings that will be described later.

In step S303, the prediction direction computing unit 103 generates, from a block input by the image buffer 101 and reference pixels according to each prediction mode output from the reference pixel buffer 111, a prediction value for each pixel and calculates the difference. The prediction direction computing unit 103 outputs all the difference pixel values obtained by computation in the nine prediction modes to the prediction mode determination unit 104. The reference pixel control unit 112 performs control according to the location of a block designated by the image data control unit 102 so that reference pixel values outputted by the reference pixel buffer 111 are appropriate for the current block to be encoded.

In step S304, the prediction mode determination unit 104 selects the optimum mode from the nine prediction modes output from the prediction direction computing unit 103 and outputs only the difference pixel values of the selected prediction mode to the integer transformation unit 105.

In step S305, the integer transformation unit 105 performs an integer transformation on the difference pixel values and outputs the resultant data to the quantization unit 106.

In step S306, the quantization unit 106 quantizes the integer-transformed data and outputs the resultant data to the entropy encoding unit 107 and the inverse quantization unit 109. The data output to the inverse quantization unit 109 is used to obtain reference pixels to be referred to in processing of blocks after the current block.

In step S307, the inverse quantization unit 109 performs inverse quantization on the data quantized by the quantization unit 106 and outputs the resultant data to the inverse integer transformation unit 110.

In step S308, the inverse integer transformation unit 110 writes only pixels to be used for prediction out of the data obtained by an inverse integer transformation to the reference pixel buffer 111.

In step S309, the entropy encoding unit 107 performs variable-length encoding on the data output from the quantization unit 106 and writes the resultant data to the encoded data buffer 108.

In step S310, the output data control unit 113 reads out the entropy encoded data from the encoded data buffer 108 after sorting the data in the order of blocks compliant with the recommendation and then outputs the data for subsequent processing. As described above, the description of the subsequent processing, for example, inter-frame predictive encoding, will be omitted.

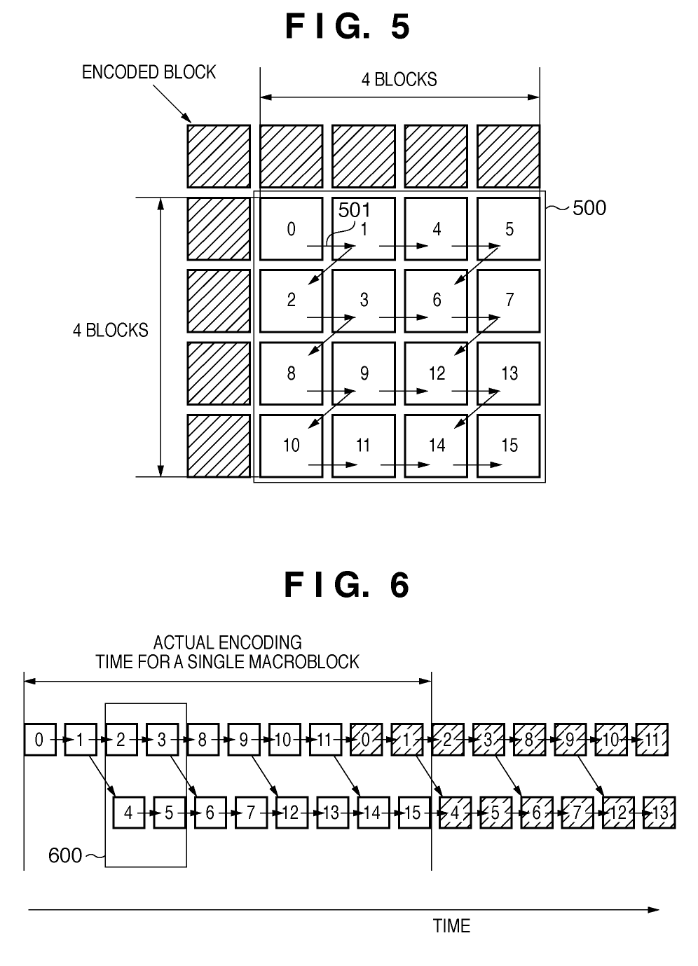

Next, pipeline processing of the blocks will be described using FIGS. 5 and 6. FIG. 5 is a diagram for explaining an example of the dependency between the blocks.

To comply with the recommendation, during processing of a target block, encoded data for four blocks, that is, blocks to the upper left, above, to the upper right, and to the left of the target block, is required. For this reason, in an initial stage of processing of a macroblock 500, only B0 can be processed. After the completion of processing of B0 up to and including inverse integer transformation, which is step S308 shown in FIG. 3, encoded data for B0 can be utilized, so B1 can be processed. This relationship is represented by the arrow 501. The other arrows similarly represent the relationship that the completion of processing of a block from which each arrow starts enables processing of a block at which the arrow ends.

When processing of B1 up to and including inverse integer transformation is completed, both B2 and B4 can be processed. In other words, the encoding process of B4 can be started at this stage. Thus, in the present embodiment, B4, which would be processed after B3 according to the recommendation, is processed in parallel with B2.

FIG. 6 is an example of a diagram illustrating pipeline processing of the blocks along a time axis. The arrows shown in FIG. 6 respectively correspond to the arrows shown in FIG. 5. Processing of B0 is followed by processing of B1. When processing of B1 is completed, B2 and B4 can be processed, so these blocks are processed in parallel. It should be noted that since only one block can be processed at a time in each step shown in FIG. 3, processing of B2 and processing of B4 are performed with a time lag therebetween. The details of this will be described later.

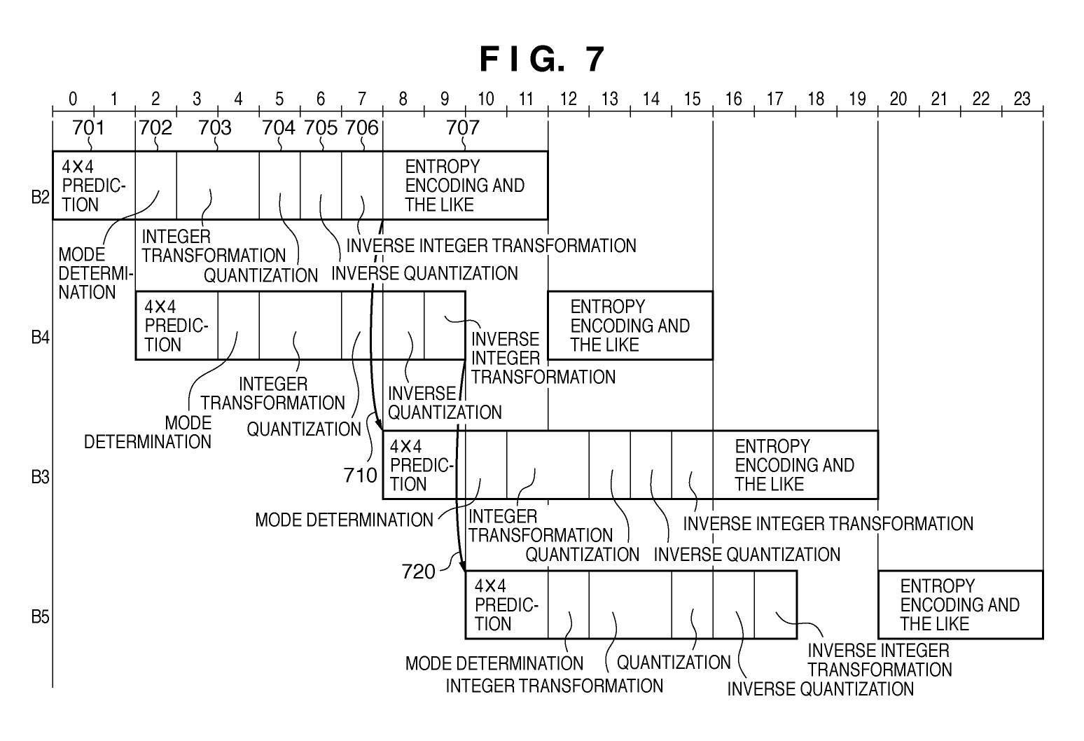

Next, the details of pipeline processing will be described using FIG. 7. FIG. 7 is a diagram for explaining an example of a time chart of pipeline processing during a period 600 shown in FIG. 6. In FIG. 7, 4×4 prediction 701 corresponds to step S303 shown in FIG. 3 and requires two unit lengths of execution time. Mode determination 702 corresponds to step S304 shown in FIG. 3 and requires one unit length of execution time. Integer transformation 703 corresponds to step S305 shown in FIG. 3 and requires one unit length of execution time. Quantization 704 corresponds to step S306 shown in FIG. 3 and requires one unit length of execution time. Inverse quantization 705 corresponds to step S307 shown in FIG. 3 and requires one unit length of execution time. Inverse integer transformation 706 corresponds to step S308 shown in FIG. 3 and requires one unit length of execution time. Entropy encoding and the like 707 corresponds to step S309 shown in FIG. 3 and requires four unit lengths of execution time. As described above, only one block can be processed at a time in each processing step. Moreover, until inverse integer transformation 706 of a block is completed, processing of 4×4 prediction 701 for a subsequent block referring to that block cannot be started.

At a stage corresponding to the period 600 shown in FIG. 6, processing of B1 has already been completed, and so 4×4 prediction 701 for B2 and B4 can be started. However, since 4×4 prediction 701 can be performed for only one block at a time, B2 is processed first and B4 is placed in a wait state in the present embodiment. That is to say, the image data control unit 102 reads out B2 from the image buffer 101 to the prediction direction computing unit 103. It should be noted that B4 may be processed prior to B2. This also applies to the relationship between other blocks such as B6 and B8. After 4×4 prediction 701 for B2 is completed, the image data control unit 102 reads out B4 from the image buffer 101 to the prediction direction computing unit 103 in order to start 4×4 prediction 701 for B4. At a time point when 4×4 prediction 701 for B4 is completed, mode determination 702 for B2 has been completed, and therefore the prediction mode determination unit 104 can subsequently start mode determination 702 for B4.

When inverse integer transformation 706 for B2 is completed, 4×4 prediction 701 for B3 can be started as can be seen from the relationship shown by the arrow 710. Accordingly, the image data control unit 102 reads out B3 from the image buffer 101 to the prediction direction computing unit 103. Similarly, when inverse integer transformation 706 for B4 is completed, the prediction direction computing unit 103 can start 4×4 prediction 701 for B5 as can be seen from the relationship shown by the arrow 720. As in the foregoing description, the image data control unit 102 reads out the blocks to the prediction direction computing unit 103 in an order in which the first block for which all the prerequisite reference pixels are available is the first to be read out, without being constrained by the encoding order specified by the recommendation. Moreover, when there is a plurality of blocks for which all the prerequisite reference pixels are available, any one of the blocks may be read out first; however, for example, the blocks are read out according to the encoding order specified by the recommendation.

Now, referring again to FIG. 6, the effect of pipeline processing according to the present embodiment will be described. When a single macroblock, that is, 16 blocks are processed in compliance with the encoding order specified by the recommendation, the required processing time is 16 times as long as a processing time from 4×4 prediction 701 to inverse integer transformation 706 even when pipeline processing is performed. However, according to the present embodiment, it takes only 10 times as long as the processing time from 4×4 prediction 701 to inverse integer transformation 706 before processing of a single macroblock is completed. Furthermore, at a stage before the completion of encoding of a macroblock, processing of the next macroblock indicated by oblique lines in FIG. 6 can be started, so that the time taken before processing of a macroblock is completed is substantially 8 times as long as the processing time from 4×4 prediction 701 to inverse integer transformation 706. That is to say, a single macroblock can be processed in about half the time required to process the macroblock in compliance with the encoding order specified by the recommendation.

After encoding by the entropy encoding unit 107, the output data control unit 113 reads out and outputs the blocks in the order compliant with the encoding order specified by the recommendation. Since the encoding processes of B0, B1, and B2 are completed in that order, these blocks are output without changing the order. The block whose encoding is completed after B2 is B4, but B4 is held in the encoded data buffer 108. After outputting B3, whose encoding is completed after B4, the output data control unit 113 reads out and outputs B4 from the encoded data buffer 108. Blocks after B4 are output in the same manner. Although processing of data read out from the encoded data buffer 108 is not defined in the present embodiment, any processing is possible as long as it is in compliance with the recommendation because the order of the read-out data is in compliance with the encoding order specified by the recommendation.

From the foregoing, according to the present embodiment, H.264 recommendation-compliant and high-speed image encoding can be performed in 4×4 intra prediction.

### Second Embodiment

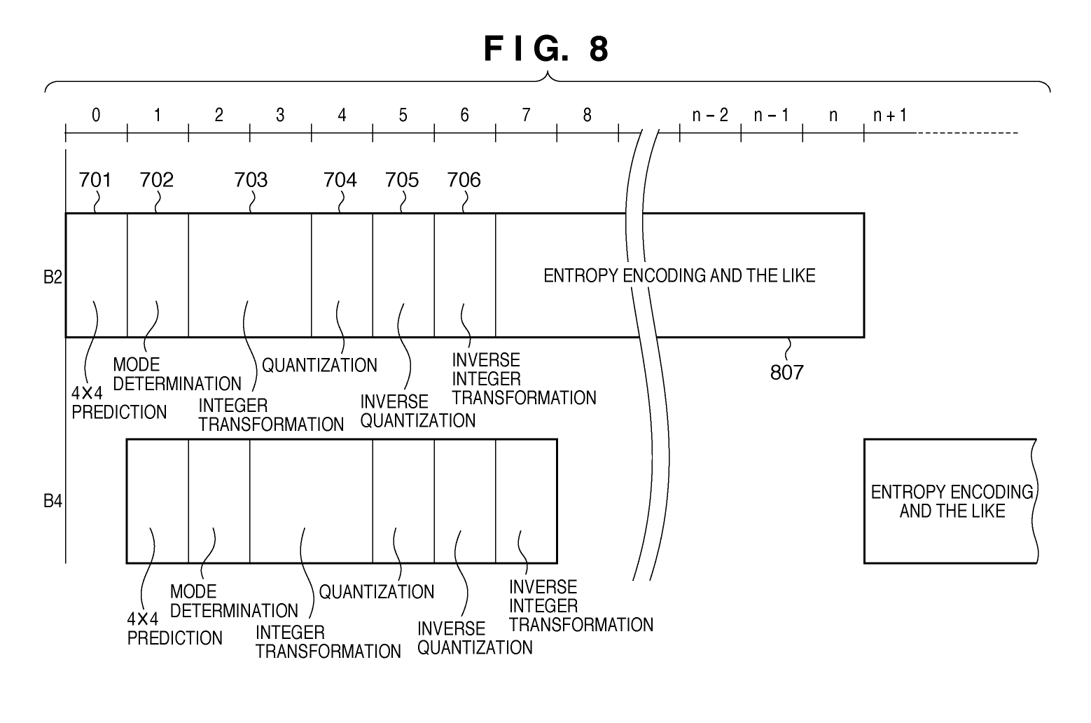

In the first embodiment, the efficiency of pipeline processing was improved by performing encoding processes in the order in which the first block for which all of the prerequisite reference pixels are available is the first to be processed. However, when entropy encoding and the like 807 takes a long processing time, in some cases, a sufficient effect cannot be obtained with the configuration of the first embodiment. An example of such a case will be described using FIG. 8.

FIG. 8 is a diagram for explaining an example of a time chart of pipeline processing in the case where entropy encoding and the like 807 takes a long processing time. In the description here, encoding processes of B2 and B4 will be focused on. At a stage when 4×4 prediction 701 for B2 is completed, 4×4 prediction 701 for B4 can be started. However, entropy encoding and the like 807 for B4 cannot be started until processing of entropy encoding and the like 807 for B2 is completed. Thus, even when processing from 4×4 prediction 701 to inverse integer transformation 706 for B4 is performed in parallel with processing for B2, the speed of the overall process up to and including entropy encoding and the like 807 cannot be increased. Therefore, the resultant processing time is almost the same as the processing time required to perform processing in compliance with the encoding order specified by the recommendation.

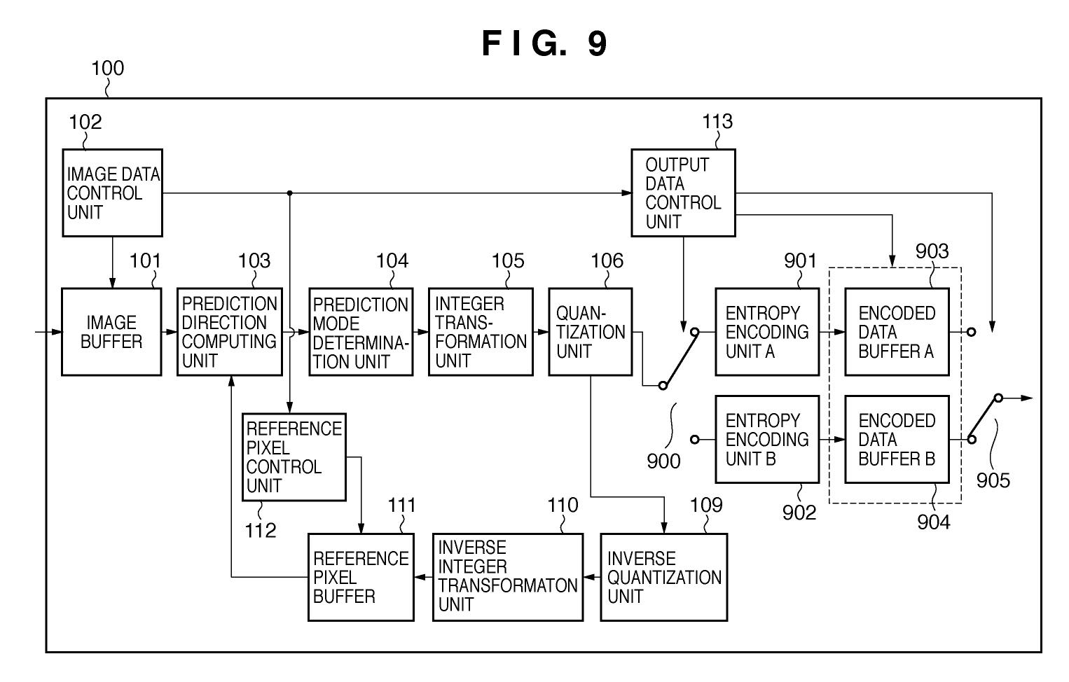

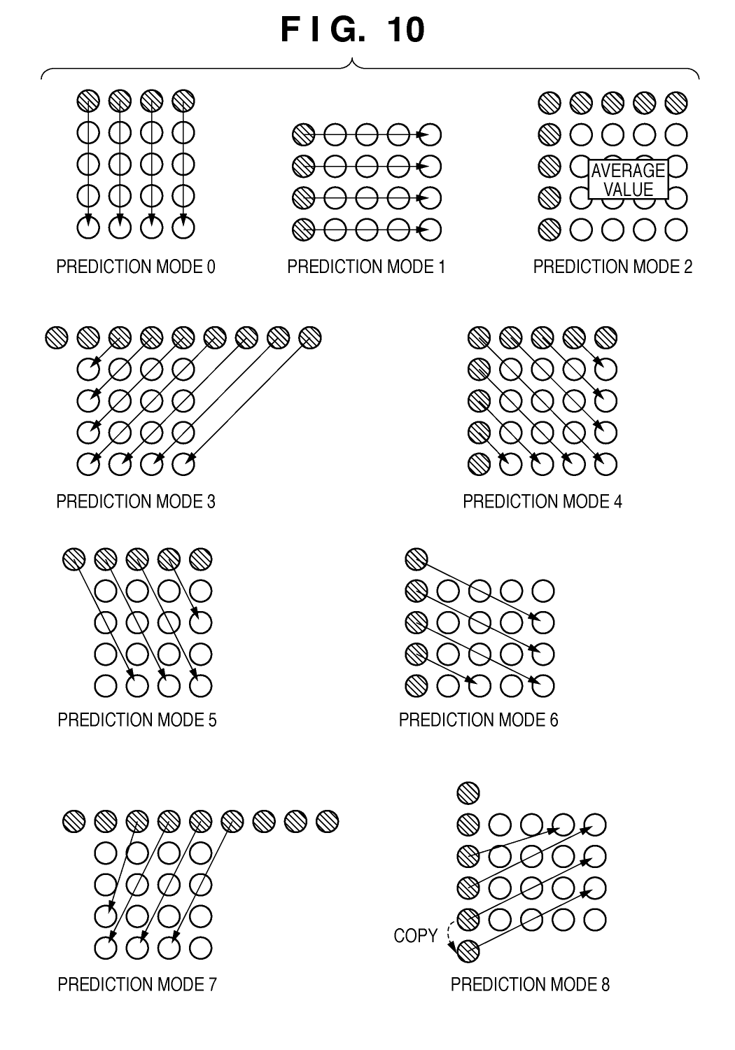

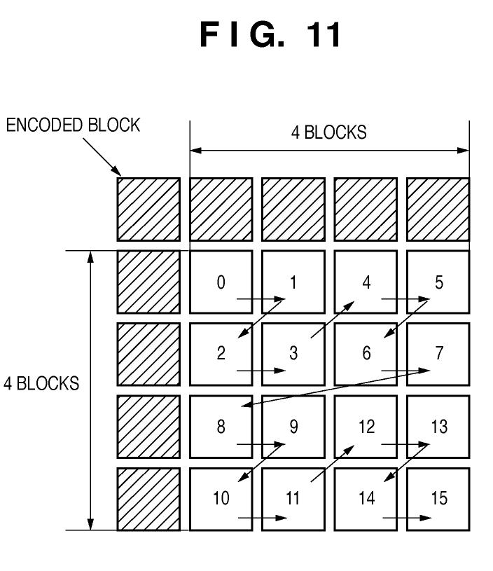

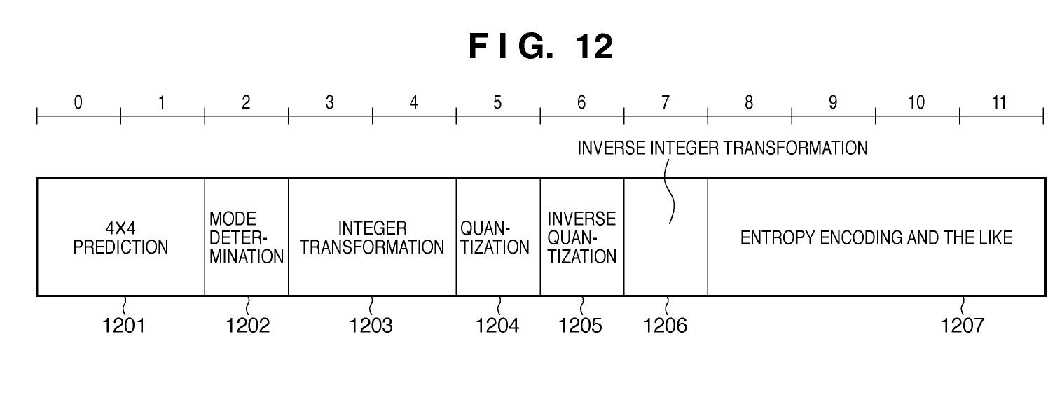

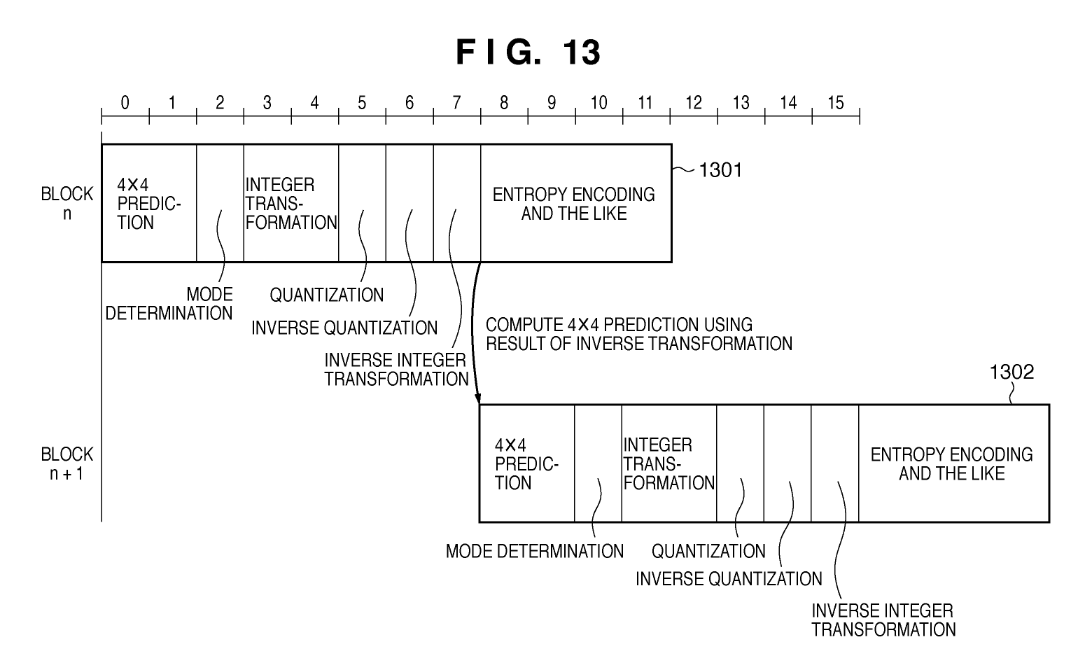

Thus, the speeding up of encoding is realized by providing two entropy encoding units as shown in FIG. 9. FIG. 9 is an example of a functional block diagram of an image encoding apparatus 100 according to a second embodiment. The same constitutional elements as those in FIG. 1 are denoted by the same reference numerals, and the description thereof will be omitted. An entropy encoding unit A 901 and an entropy encoding unit B 902 each perform variable-length encoding on a value quantized by the quantization unit 106. An encoded data buffer A 903 and an encoded data buffer B 904 hold an encoded block outputted by the entropy encoding unit A 901 and the entropy encoding unit B 902, respectively. An input switch 900 switches the destination of output from the quantization unit 106 according to instructions from the output data control unit 113. An output switch 905 switches to the encoded data buffer that holds encoded data to be read out, according to instructions from the output data control unit 113.

The output data control unit 113 switches the input switch 900 so that output from the quantization unit 106 is outputted to the entropy encoding unit that is not performing processing. As previously described using FIG. 6, the number of blocks that are processed in parallel is at most two, so the output can be supplied to either one of the entropy encoding units. Then, the output data control unit 113 outputs the encoded blocks from the encoded data buffer A 903 and the encoded data buffer B 904 while switching the output switch 905 so that the blocks are output in the encoding order specified by the recommendation.

As described above, even when entropy encoding processing and the like takes a longer period of time than the other processing steps, H.264 recommendation-compliant and high-speed image encoding can be performed in 4×4 intra prediction.

### Other Embodiments

The above-described exemplary embodiments of the present invention can also be achieved by providing a computer-readable storage medium that stores program code of software (computer program) which realizes the operations of the above-described exemplary embodiments, to a system or an apparatus. Further, the above-described exemplary embodiments can be achieved by program code (computer program) stored in a storage medium read and executed by a computer (CPU or micro-processing unit (MPU)) of a system or an apparatus.

The computer program realizes each step included in the flowcharts of the above-mentioned exemplary embodiments. Namely, the computer program is a program that corresponds to each processing unit of each step included in the flowcharts for causing a computer to function. In this case, the computer program itself read from a computer-readable storage medium realizes the operations of the above-described exemplary embodiments, and the storage medium storing the computer program constitutes the present invention.

Further, the storage medium which provides the computer program can be, for example, a floppy disk, a hard disk, a magnetic storage medium such as a magnetic tape, an optical/magneto-optical storage medium such as a magneto-optical disk (MO), a compact disc (CD), a digital versatile disc (DVD), a CD read-only memory (CD-ROM), a CD recordable (CD-R), a nonvolatile semiconductor memory, a ROM and so on.

Further, an OS or the like working on a computer can also perform a part or the whole of processes according to instructions of the computer program and realize functions of the above-described exemplary embodiments.

In the above-described exemplary embodiments, the CPU jointly executes each step in the flowchart with a memory, hard disk, a display device and so on. However, the present invention is not limited to the above configuration, and a dedicated electronic circuit can perform a part or the whole of processes in each step described in each flowchart in place of the CPU.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-153394, filed Jun. 11, 2008, which is hereby incorporated by reference herein in its entirety.

What is claimed is:

1. An image encoding apparatus that performs intra-frame predictive encoding, comprising:
a partitioning unit configured to partition an inputted macroblock into blocks as processing units;
an encoding unit configured to encode each of blocks to be processed using a prediction value for each pixel contained in the block to be processed, the prediction value being calculated by referring to pixels contained in other blocks; and
a sorting unit configured to sort the encoded blocks in a predetermined encoding order,
wherein the encoding unit starts encoding in an order in which the first block for which all the pixels to be referred to are available for calculation of the prediction value is the first to be encoded, and the encoding is performed by pipeline processing.

2. The apparatus according to claim 1, wherein when there is a plurality of blocks for which all the pixels to be referred to are available, the encoding unit encodes the plurality of blocks according to the predetermined encoding order.

3. The apparatus according to claim 1, wherein the encoding unit comprises:
a plurality of entropy encoding units configured to perform entropy encoding on each of the partitioned blocks; and
a switching unit configured to input each of the partitioned blocks to any one of the plurality of entropy encoding units that can accept the block.

4. The apparatus according to claim 3, wherein the number of the plurality of entropy encoding units is two.

5. The apparatus according to claim 1, wherein the predetermined encoding order is an encoding order compliant with the H.264 recommendation.

6. A method of controlling an image encoding apparatus that performs intra-frame predictive encoding, the method comprising the steps of:
partitioning an inputted macroblock into blocks as processing units;
encoding each of blocks to be processed using a prediction value for each pixel contained in the block to be processed, the prediction value being calculated by referring to pixels in another block; and
sorting the encoded blocks in a predetermined encoding order,
wherein at the encoding step, encoding is started in an order in which the first block for which all the pixels to be referred to are available for calculation of the prediction value is the first to be encoded, and the encoding is performed by pipeline processing.

7. A computer-readable storage medium containing computer-executable instructions for controlling a computer to function as the image encoding apparatus according to claim 1.
